(19) United States
(12) Patent Application Publication
(10) Pub. No.: US 2026/0366588 A1
(43) Pub. Date: Nov. 19, 2026

(54) TENSION ELEMENT FOR AN ISOLATION MOUNT

(71) Applicant: Hutchinson Aerospace & Industry, Inc., Hopkinton, MA (US)

(72) Inventors: Grete B. Bressner, Millis, MA (US); Shawn A. Czerniak, Norwood, MA (US); Neil Donovan, Cary, NC (US); Anthony C. Lopez, Groton, MA (US); John C. Sailhamer, Canton, MA (US)

(21) Appl. No.: 19/576,662

(22) Filed: Mar. 24, 2026

Related U.S. Application Data
(60) Provisional application No. 63/806,437, filed on May 15, 2025.

(51) Int. Cl. F16F 3/12

(52) U.S. Cl. CPC F16F 3/12; F16F 2224/0208; F16F 2224/0241; F16F 2224/025; F16F 2226/042; F16F 2230/0005; F16F 2234/02

(57) ABSTRACT

The tension element includes a first attachment structure, a second attachment structure, a strap engaged with the first and second attachment structures, an elastomeric element disposed within the strap, and a plurality of restrictors to pinch the strap to form a holders holding the elastomeric element. The strap compresses the elastomeric element while the strap is pulled in the tensile direction. The tension element allows the tension resisting forces to grow at an increasing rate as the tensile force increases thereby providing a soft, inherently stable snubbing condition. This relationship between the tension resisting forces and tension deflection can be tailored by adjusting material properties and dimensions and shapes of the flexible strap, restrictors, the elastomer bars and the rigid elements.

### CROSS-REFERENCES

This application claims priority of U.S. provisional application Ser. No. 63/806,437 filed May 15, 2025 and titled “Tension Element for an Isolation Mount” by the present inventors.

### BACKGROUND

Flexible, or resilient, mounts are used to reduce the transmission of noise, shock, and vibration in large and small systems in all industries, for example, marine use or industrial use. The flexible mounts commonly have increasing stiffness in the compressive direction, which functions as a deflection limiter. In the tension direction, limiting the motion while retaining a gradual spring rate poses a difficult problem. Elastomeric spring isolation systems in the tension direction typically see unlimited travel, making it difficult to design a geometry that results in increasing stiffness with deflection. For this reason, flexible mounts can incorporate secondary spring elements, also referred to as snubbing components into their designs to restrict motion during extreme loading events. The snubbing components, also known as “snubbers,” are devices that limit travel in a flexible system.

Secondary spring elements can be categorized as hard snubbers or soft snubbers. Hard snubbers generally have a non-linear, rapidly changing relationship between load applied and load resistance, while soft snubbers typically have a gradual increase in load resistance as applied load increases.

Soft snubbers are typically used to resist motion in compressive directions. The use of soft snubbers in tension loading conditions can be problematic. Conventional tension soft snubbers can be bulky, heavy, and/or have a strong influence in load vs. deflection relationships in off-axis directions. In many instances, the design accommodations and requirements to include conventional soft snubbing into a mounting system become too complex. In these instances, hard snubbers are used instead which can result in degraded performance of the mounting system.

For the foregoing reasons, there is a need for improved soft snubbing in an isolation system.

### SUMMARY

Embodiments of the present disclosure provide a system for isolation where the tension elements have stable snubbing. The term “stable snubbing” refers to a load/deflection relationship in which load increases as deflection increases. Isolation mounts in tension typically have a decreasing load/deflection relationship as deflection increases.

The tension element has individual elastomeric elements that resist compression elements to provide stable snubbing. The tension element is lightweight and compact and is capable of providing stable snubbing in tension while minimizing impact to load/deflection relationships in non-tension axes. The tension element, while referred to as an element that is capable of providing stable snubbing, can also act as a simple spring or isolator.

The tension element is believed to be useful in marine applications particularly for large structural isolation. Example applications include large deck mounts and generator mounts. These are merely some examples of use. The tension element should not be considered limited to the applications listed here.

The tension element has a plurality of embodiments having characteristics that can be modified and tuned to provide particular performance. In a first embodiment, the elastomeric elements are elastomer bars that are cylindrical in shape. In various alternative embodiments, the cylinders have various lengths, inner diameters and outer diameters. In further alternative embodiments, the elastomer bars have shapes other than cylindrical such as square, triangular, or trapezoidal. In still further alternative embodiments, the elastomeric element is instead a spring element. Examples of spring elements include coiled springs and contained incompressible fluid. The spring element may be any element that provides the desired spring force or spring rate.

The elastomer bars can further include rigid elements. In a first embodiment, these rigid elements are cylindrical in shape. In various alternative embodiments, the cylindrical rigid elements have various lengths, inner diameters and outer diameters. In other alternative embodiments, the relationship between the inner geometry of the elastomer bar and the outer geometry of the rigid element could also be varied where in one arrangement the two geometries are the same and in a second arrangement, the elastomer bar inner geometry is larger than the rigid element outer geometry providing a loose fit and in a third arrangement, the elastomer bar inner geometry is smaller than the rigid element outer geometry providing an interference fit. Alternative embodiments of the tension element may have different numbers of elastomer bars from those shown and described below. Alternative embodiments of the tension element may have a different number of rigid elements from those shown and described below. Alternative embodiments of the tension element may have different numbers of restrictors from those shown and described below. Alternative embodiments of the tension element may have flexible loops with different spacing than those shown and described below. In alternative embodiments, the flexible loops have various lengths, widths, and thicknesses according the particular application.

In one embodiment, the flexible elements are flexible and with minimal elasticity. In alternative embodiments, the flexible loops are made out of other types of materials that are able to withstand the resistive forces of the elastomer bars in operation.

In one or more embodiments, a tension element includes a first attachment structure, a second attachment structure, a strap engaged with the first and second attachment structures, at least one compressible element disposed within the strap, and, a plurality of restrictors to pinch the strap to form a plurality of holders holding the plurality of compressible elements. The tension element allows the tension resisting forces to grow at an increasing rate as the tensile force increases thereby providing a soft, inherently stable snubbing condition. The tension element is a mechanism for transferring tension deflection of the isolator mount system into a compression load on the elastomer bars.

In another alternative embodiment of the tension element, each of the compressible elements is an elastomer bar. In a first arrangement, the elastomer bars are cylindrical. The compressible elements provide soft, gradually increasing load resistance.

In one alternative embodiment of the tension element, each of the compressible elements is coupled to the at least one strap. In one or more alternative arrangements, the coupling is accomplished with adhesion. The straps translate the tensile load on the tension element to compression on the compressible elements.

In further alternative embodiments of the tension element, each elastomer bar further includes a rigid element. In at least one alternative arrangement, the rigid element is a steel rod. The rigid element provides stabilization for the compressible elements as well as a hard stop for the compression. The rigid element dimensions and materials can be adjusted as part of the tuning of the tension element. In further alternative arrangements, there are no rigid elements.

In one or more alternative embodiments of the tension element, the first and second attachment structures are restrictors. This embodiment reduces the number of different parts needed to make the tension element.

In one or more alternative embodiments of the tension element, the first attachment structure and the second attachment structure each further include a channel where the channel is formed and configured to engage with one of the least one strap. The channels hold the straps in proper placement on the attachment structures as well as within the tension element. In a further embodiment of the first and second attachment structure, each further include a plurality of channels. Spacing between the channels can be changed in order to meet particular needs of implementation.

In one or more alternative embodiments of the tension element, each restrictor is made up of coupled opposing bars. In some embodiments the bars are made of metal. In some embodiments, the bars are a composite material. Various materials are used depending on the conditions of tension element implementation, such as environmental conditions. In one or more further embodiments, each restrictor is a sleeve or ring.

In one or more alternative embodiments of the tension element, the strap, alternatively referred to as the flexible element, is made of metal. In one or more alternative embodiments, the strap is made of a woven material. In some alternative arrangements, the woven material is made of metal. In further alternative arrangements, the woven material is a woven reinforced composite material. In further alternative arrangements, the woven material comprises a stretch-resistant fiber. The various materials provide flexibility in designing the tension element to be installed in different environments, enable flexibility in the weight of the system, interaction with other elements such as the mount and flexibility in tuning snubbing action.

In one or more embodiment, a tension element includes a first attachment structure having a first plurality of channels and a second attachment structure having a second plurality of channels. The tension element further includes a plurality of straps formed and configured to engage with the first and second attachment structures where each strap of the plurality of straps engages with a channel of the first plurality of channels and also with a corresponding channel of the second plurality of channels. The tension element further includes a plurality of elastomer bars disposed within the plurality of straps where each of the plurality of elastomer bars further including an axially-located rigid rod. The tension element still further includes a plurality of restrictors. Each restrictor has a first bar and a second bar located in opposition. The plurality of restrictors clamps the plurality of straps at selected locations thereby forming a plurality of holders containing the plurality of elastomer bars. A tensile force on the tension element causes the plurality of straps to exert a compressive force on the plurality of elastomer bars thereby providing soft resistance to the tensile force.

The present invention together with the above and other advantages may best be understood from the following detailed description of the embodiments of the invention illustrated in the drawings, wherein:

### DRAWINGS

FIG. 1 is a first perspective view of a tension element for an isolation mount according to principles of the invention;

FIG. 2 is a second perspective view of the tension element of FIG. 1;

FIG. 3 is a side view of the tension element of FIG. 1;

FIG. 4 is a front view of the tension element of FIG. 1;

FIG. 5 illustrates the attachment structure of the embodiment of FIG. 1;

FIG. 6 illustrates an alternative embodiment of the attachment structure;

FIG. 7 illustrates another alternative embodiment of the attachment structure;

FIG. 8 illustrates the tension element functionality under compressive load, lateral load, and fore-aft load;

FIG. 9 illustrates the tension element functionality under tensile load;

FIG. 10 illustrates the tension element deflections under tensile load;

FIG. 11 is a perspective view of an alternative embodiment of the tension element; and FIG. 12 is a perspective view of a further alternative embodiment of the tension element.

FIG. 13 is a side view of the tension element of FIG. 12; and,

FIG. 14 illustrates an elastomer bar suitable for use in the tension element embodiment of FIG. 12.

### DESCRIPTION

It is to be understood that the following disclosure describes several exemplary embodiments for implementing different features, structures or functions of a tension element. Exemplary embodiments of components, arrangements and configurations are provided merely as examples and are not intended to limit the scope of the invention. It will be clear and apparent to those skilled in the art that the subject technology is not limited to the specific details set forth herein.

In one or more embodiments, a tension element includes a first attachment structure, a second attachment structure, a strap engaged with the first and second attachment structures, at least one elastomeric element disposed within the strap, and a plurality of restrictors to pinch the strap to form a plurality of holders holding the at least one elastomeric element. The strap compresses the elastomeric elements while the strap is pulled in the tensile direction. The tension element allows the tension resisting forces to grow at an increasing rate as the tensile force increases thereby providing a soft, inherently stable snubbing condition. This relationship between the tension resisting forces and tension deflection can be tailored by adjusting material properties and dimensions and shapes of the flexible loops, restrictors, the elastomer bars and the rigid elements.

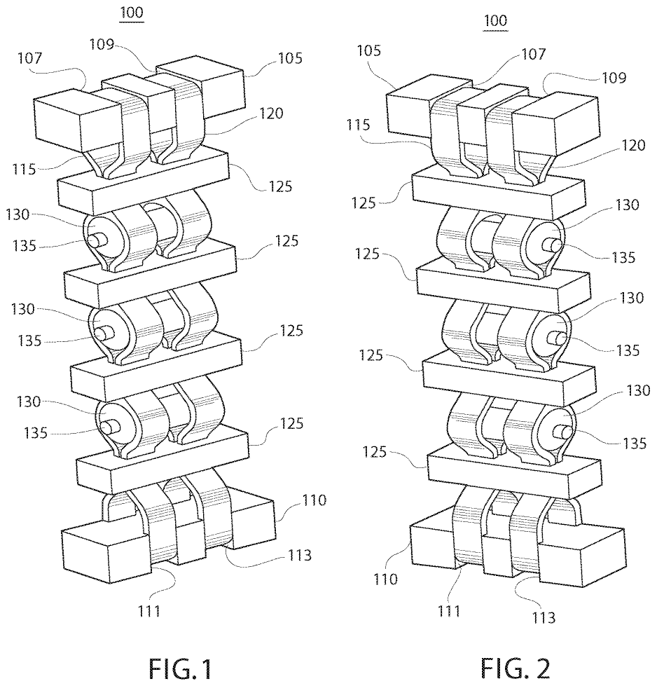

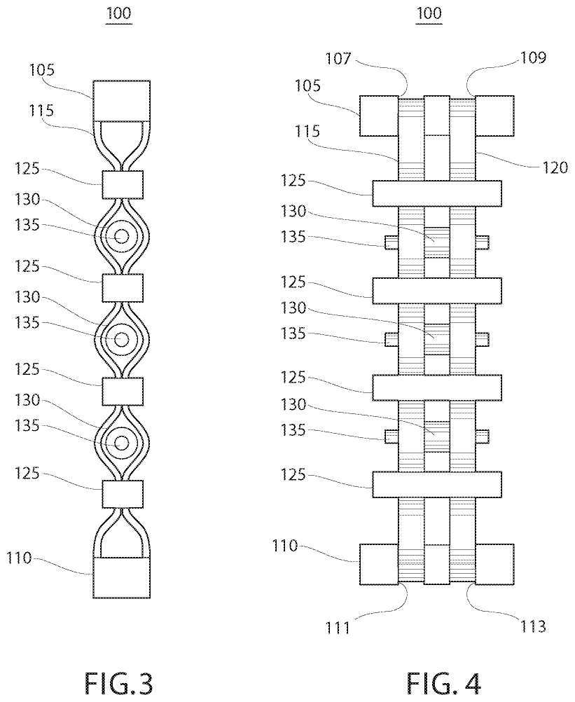

FIGS. 1-4 illustrate a tension element 100 for an isolation mount. FIG. 1 and FIG. 2 are perspective views of the tension element 100. FIG. 3 is a side view of the tension element 100. FIG. 4 is a front view of the tension element 100.

The tension element 100 has a first attachment structure 105 and a second attachment structure 110. The tension element 100 further includes two flexible loops 115, 120, alternatively referred to as straps, a plurality of restrictors 125, a plurality of elastomer bars 130, and a plurality of rigid elements 135.

The first and second attachment structures 105, 110 are used to attach the tension element to the top of an isolation mount and to the bottom of the isolation mount respectively. The isolation mount is not shown in FIGS. 1-4. The first and second attachment structures 105, 110 further provide attachment for the two flexible loops 115, 120 of the tension element 100, that is, the first and second attachment structures 105, 110 operate as holders for the loops 115, 120. In the present embodiment, the attachment structures 105, 110 each include two channels 107, 109, 111, 113. Each channel 107, 109, 111, 113 is formed and configured to hold and support one of the two flexible loops 115, 120. The attachment structures 105, 110 are substantially rigid. The material may be any material, for example, steel, that is able to support the requirements of the particular application of the tension element. The geometry of the attachment structure may vary to further support the requirements of the application of the tension element, for example, the attachment structure can be rectangular or curved. The attachment to the mount or adjacent structure is typically accomplished with mechanical connections such as bolts, welding or a mechanical interface.

The flexible loops 115, 120, also referred to as “belts” or “straps,” each circle the first and second attachment structures 105, 110. The flexible loops 115, 120 are preferably made from a material that substantially resists deformation or stretching under tension. The flexible loops 115, 120 are, for example, woven straps. Various weave configurations are possible in embodiments of the invention. In a first embodiment, the flexible loops 115, 120 are made of woven metal. In a second embodiment, the flexible loops 115, 120 are made of woven reinforced composite material. Alternatively, the flexible loops 115, 120 may be made of any material that is flexible or pliable when the tension element 100 is in compression but resistive and non-compliant when the tension element 100 is in tension. In a further alternative embodiment, the flexible loops 115, 120 are made of non-woven metal.

The plurality of restrictors 125, also called “clamp bars” or “restraining bars,” are devices that pinch the flexible loops 115,120 together to form holders to contain the elastomer bars 130. The restrictors 125 are structurally stiff and are formed and configured to hold opposing sections of the flexible loops 115, 120 together as shown. The restrictors 125 are, for example, made of metal. In some arrangements, the restrictors 125 may be implemented as sleeves or rings. Alternatively, the opposing sections of the flexible loops 115, 120 may be stitched together. Further alternatively, the restrictors 125 may be any method of attaching the opposing sections of the flexible loops 115, 120 together in a manner that resists being pulled apart when the tension element 100 is under tension. These alternative methods include clamping mechanisms, restraining mechanisms, or another type of mechanical fastener.

The plurality of elastomer bars 130 are located in the holders formed by the flexible loops 115, 120 and held together by the restrictors 125. Each elastomer bar 130 is generally cylindrical in shape. The elastomer bars 130 are made of a semi-flexible elastomer. They may be any elastomer that meets the needs of the application of the isolation mount. That is, the elastomer bars may be made of an elastomer of very low durometer to one of very high durometer, for example, in the range of 25-75 on the Shore durometer scale. In general, the preferred elastomer provides a low elastic modulus relative to the flexible loop in the tension direction, thereby providing the snubbing characteristic of the tension element 100, which will be described in greater detail below. Other considerations in selecting the elastomer include environmental elements including chemicals and temperatures. In a first embodiment, the elastomer bars 130 are merely held by the restricted flexible loops 115, 120. In a second embodiment, the elastomer bars 130 are bonded to the flexible loops 115, 120. In a third embodiment, the elastomer bars 130 are formed and configured to have channels similar to the channels in the attachment structures 105, 110. The elastomer bar channels in this embodiment are formed and configured to hold the flexible loops 115, 120 which then prevent the elastomer bars 130 from sliding out of the holders. The elastomer bars 130 shown in FIGS. 1-4 are circular in cross-section, however, other embodiments of elastomer bars may be oval, square or diamond-shaped in cross-section. Embodiments should not be considered limited to elastomer bar shapes listed here.

Each elastomer bar 130 includes a rigid element 135 located along the axis of the elastomer bar 130. Typically, the rigid element 135 is a metal bar, for example a steel bar. Alternatively, the rigid element 135 could be made out of any material with sufficient rigidity. The rigid element 135 could, for example, be made of a composite material such as carbon fiber reinforced plastic. The rigid element 135 provides some rigidity to the elastomer bar 130 to reduce bending of the elastomer bar 130 under uneven tension from the flexible loops 115, 120. The rigid element 135 is also useful in tailoring the tension load deflection curve in the elastomer bar 130. Further, the rigid element 135 provides a compression stop for the elastomer bar 130. The rigid element 135 shown in the figures is circular in cross-section, however, the rigid element may be square, diamond-shaped or oval in cross-section in alternative embodiments. Embodiments should not be considered limited to the rigid element shapes listed here.

In operation, a load force putting the tension element 100 under tension is translated by the flexible loops into a compressive load on the elastomer bars 130. The tension element 100 thereby provides the protection of resistance to excess motion in tension with the advantages of soft snubbing.

Other attachment configurations of the tension element are possible such as attaching tension element 100 adjacent to the isolation mount. Further configurations include, but are not limited to, a plurality of tension elements 100 used in a single isolation mount, and a single or plurality of tension elements 100 being shared by multiple isolation mounts. The attachment structure in a first arrangement is attached to the isolation mount with screws and in a second arrangement is attached to the isolation mount with brackets. The present inventions should not be considered limited to those attachment methods for the attachment structure described here. Other means of attaching the tension element to the isolation mount are possible.

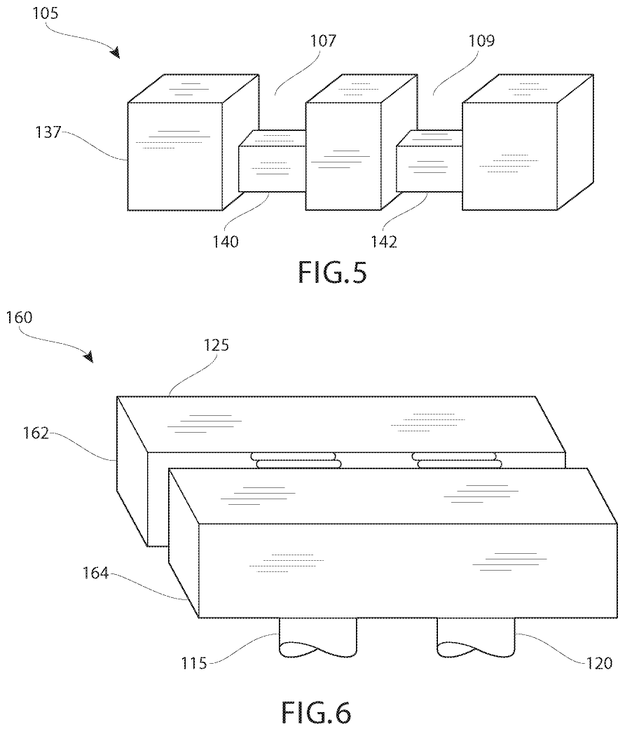

FIG. 5 illustrates the first attachment structure 105 of FIGS. 1-4. The attachment structure 105 in this embodiment is a block 137 having a first channel 107 and a second channel 109 cut into the block leaving a first support bar 140 and a second support bar 142 for engagement with the flexible loops. Further, the channels operate to maintain the flexible loops 115, 120 on the attachment structure 105 both when the tension element 100 is not under a load and while the tension element 100 is operating. The second attachment structure 110 is similar to the first attachment structure 105 and mounted in opposition.

FIG. 6 is an alternative embodiment of an attachment structure. The attachment structure 160 in FIG. 6 is a restrictor 125 from FIGS. 1-4 that may be further configured to attach to an isolation mount. The isolation mount attachments are not shown however can be readily understood and implemented by those skilled in the art. The restrictor 125 has a first restrictor piece 162 and a second restrictor piece 164 formed and configured to hold portions of the flexible loops 115, 120 between them. The first restrictor piece 162 and second restrictor piece 164 in various alternative arrangements are held together using for example screws, clamps, or adhesives. The flexible loops 115, 120 are contained in the restrictor 125 by friction in a first arrangement. In an alternative arrangement, the flexible loops 115, 120 are joined to the restrictor pieces with adhesive. Other methods of fastening the restrictor pieces 162, 164 together and of maintaining the flexible loops 115, 120 in position in the restrictor 125 are possible within the scope of embodiments of the invention.

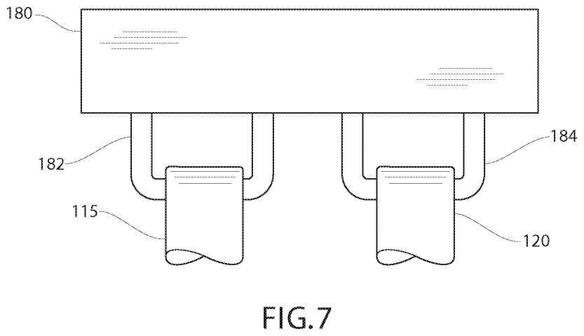

FIG. 7 is another alternative embodiment of an attachment structure 180. In this embodiment, a first u-bend 182 and a second u-bend 184 are attached to a side of the attachment structure 180. The u-bends 182, 184 are flattened at the bottom of the “u”. Each u-bend 182, 184 holds a flexible loop 115, 120.

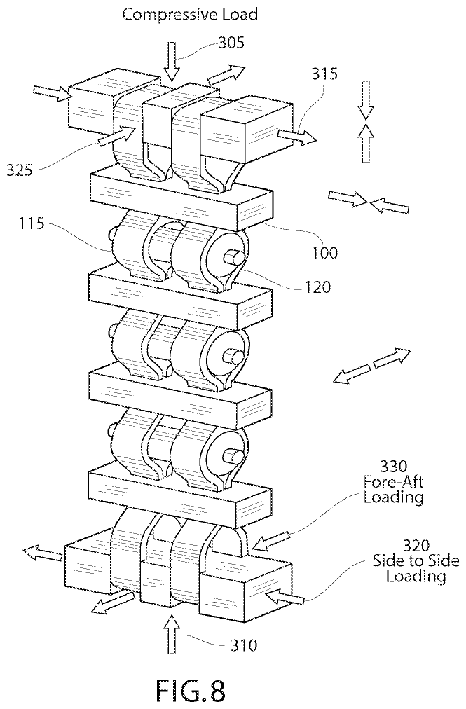

FIG. 8 illustrates the tension element functionality under compressive load 305, 310, lateral load (side to side) 315, 320, and fore-aft load 325, 330. When the tension element 100 is installed into a mount (also referred to as the “mount system”), and a compressive load 305, 310 is applied to the mount, the flexible belts 115, 120 allow the tension element 100 to buckle thereby providing effectively no resistive forces. When the mount is subjected to lateral forces 315, 320 (that is, “side to side loading”), the flexible belts 115, 120 enables the tension element 100 to flex and therefore provide effectively no resistive forces. When the mount is subjected to fore-aft load 325, 330, the flexible belts 115, 120 enables the tension element 100 to flex and therefore to provide effectively no resistive forces.

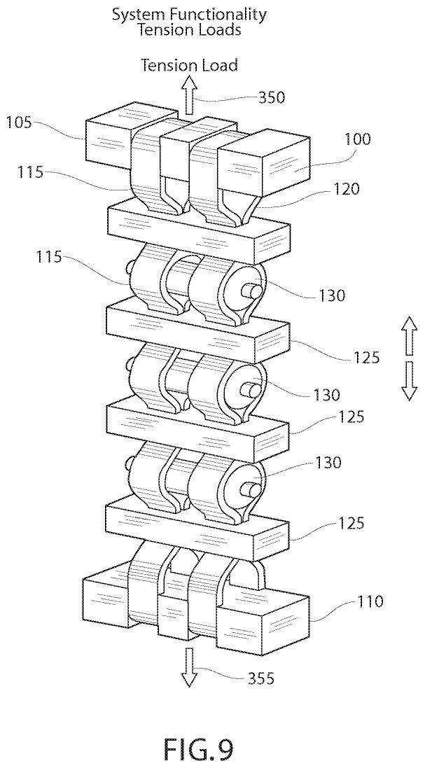

FIG. 9 illustrates the tension element functionality under tensile load, also referred to as “tension load”. When the tension element 100 is installed into a mount or a mount system (not shown), and a tension load 350, 355 is applied to the mount, the two attachment structures 105, 110 pull on the flexible loops 115, 120. As the tensile load 350, 355 pulls the two attachment structures 105, 110 away from each other, tension is applied also to the flexible loops 115, 120. Since the flexible loops 115, 120 are both non-elastic and restricted at a plurality of points by the restrictors 125, the flexible loops 115, 120 tend to compress the elastomer bars 130 as the curved loop geometry decreases. In that way, the loads 350, 355 applied by the two attachment structures 105, 110 are translated into forces on the elastomer bars 130. As the flexible loops 115, 120 are pulled taut, the compression of the elastomer bars 130 results in a tension resisting force being transmitted back to the mount.

The material makeup of the elastomer bars 130, the geometry of the elastomer bars 130 and the rigid elements 135 in the elastomer bars 130 all influence the relationship between tension resisting forces and tension deflections. That is, the materials may be stiffer or more flexible and the diameters and or geometries of the elastomer bars and rigid elements may be changed in order to tune the tension element for particular applications. The tension element 100 allows tension resisting forces to grow at an increasing rate as the mount moves in tension thereby providing a soft, inherently stable snubbing condition to exist. This relationship between the tension resisting forces and the tension deflections can be tailored by adjusting material properties and dimensions and shapes of the elastomer bars and the rigid elements.

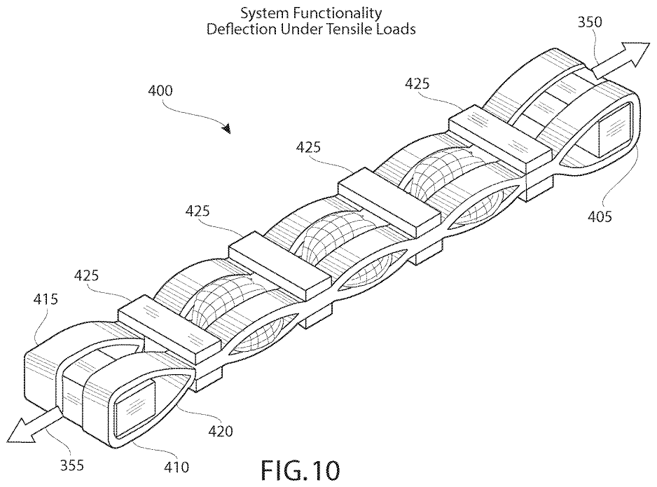

FIG. 10 illustrates tension element deflections under tensile load. FIG. 10 shows a stress analysis model 400 of a tension element such as the tension element 100 of FIG. 1. The model 400 has a first attachment structure section 405 and a second attachment structure section 410, models of flexible loops 415, 420, restrictor sections 425, and compressible elements 430 which are combinations of the elastomer bars and rigid elements such as those 130, 135 of FIG. 1. Under tensile forces 350, 355, the two attachment structures sections 405, 410 pull on the flexible loops 415, 420. Since the flexible loops 415, 420 are both non-elastic and restricted at a plurality of points, that is, at each restrictor section 405, the flexible loops 415, 420 tend to straighten and become taut as the two attachment structures sections 405, 410 are pulled away from each other in tension. The straightening flexible loops 415, 420 tend to compress the compressible elements 430 as the curved geometry in the flexible loops 415, 420 tends to flatten. The compressible elements 430 deform and resist compression.

The model shows small deflections in both the attachment structure sections 405, 410 in response to the tensile forces 350, 355 and the opposing resistance of the flexible loops 415, 420 and the compressible elements 430. The compressible elements 430 show strong deflections from the compressive behavior of the flexible loops 415, 420. The model 400 shows how the tension resistance increases with the increasing compression of the compressible elements 430.

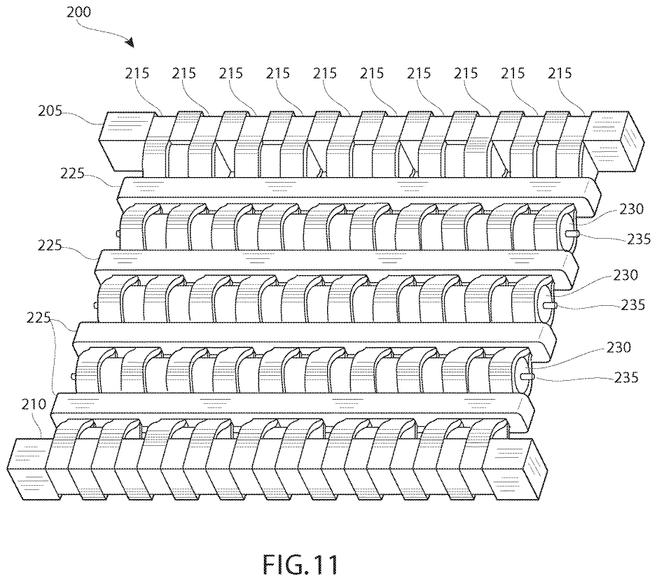

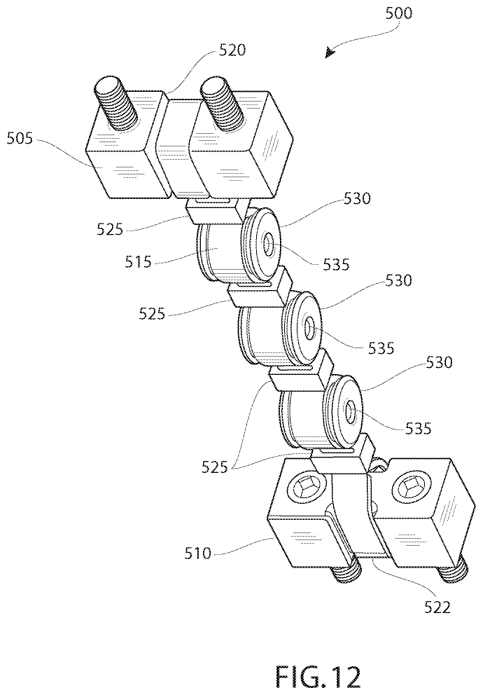

FIG. 11 is a perspective view of an alternative embodiment. In this alternative embodiment, the tension element 200 has a first attachment structure 205 and a second attachment structure 210. The tension element 200 further includes a plurality of flexible loops 215, a plurality of restrictors 225, a plurality of elastomer bars 230 with rigid elements 235. The first and second attachment structures 205, 210 and elastomer bars 230 are longer in order to accommodate more flexible loops. The tension element 200 operates similarly to the tension element 100 described above. The tension element can be sized according to the needs of the application.

The first and second attachment structures 205, 210 are used to attach the tension element 200 to the top of an isolation mount and to the bottom of the isolation mount respectively. The attachment is accomplished, for example, but not limited to, by bolts through holes located in the bolt shear direction. The isolation mount, the attachment means including the holes and bolts are not shown. The first and second attachment structures 205, 210 further provide attachment for the flexible loops 215. The attachment structures 205, 210 each include channels, also referred to as grooves. The channels are preferably evenly spaced however alternative spacing is possible in alternative embodiments. Each channel is formed and configured to hold and support one of the flexible loops. The attachment structures 205, 210 are typically made of metal, such as steel, and are substantially rigid.

The flexible loops 215, also referred to as belts or straps, each circle the first and second attachment structures 205, 210. The flexible loops 215 are preferably made from a material that substantially resists deformation or stretching under tension. The flexible loops 215 are typically woven straps and are, for example, made of Kevlar®. FIG. 11 shows a tension element having ten straps, however other embodiments may have more or fewer straps in order to accomplish snubbing in particular applications.

The plurality of restrictors 225, also called “clamp bars” or “restraining bars,” are devices that pinch the flexible loops 215 together to form holders to contain the elastomer bars 230. The restrictors 225 are structurally stiff and are formed and configured to hold opposing sections of the flexible loops 215 together as shown. The restrictors 225 are, for example, made of metal such as steel. The opposing bars in each restrictor are, for example, bolted together.

The plurality of elastomer bars 230, also referred to as “elastomeric elements” or “compressible elements,” are located in the holders formed by the flexible loops 215 and restrictors 225. Each elastomer bar 230 is generally cylindrical in shape. The elastomer bars 230 are adhesively bonded to the flexible loops 215.

Each elastomer bar 230 includes a rigid element 235, also referred to as a “rod,” located along the axis of the elastomer bar 230. Typically, the rigid element 235 is a metal bar, for example a steel bar. In this and other embodiments, the rigid element 235 is molded into the elastomer bar 230. The rigid element 235 provides some rigidity to the elastomer bar 230 to reduce bending of the elastomer bar 230 under uneven tension from the flexible loops 215. The rigid element 235 is also useful in tailoring the tension load deflection curve in the elastomer bar 230. Further, the rigid element 235 provides a compression stop for the elastomer bar 230.

In this and other embodiments, the tension element 200 is encapsulated. The encapsulating material includes, for example, rubber or plastic or some other compliant material.

In operation, a load force putting the tension element 200 under tension is translated by the flexible loops into a compressive load on the elastomer bars 230. The tension element 200 thereby provides the protection of resistance to excess motion in tension with the advantages of soft snubbing by transferring tension deflection of the isolator mount system into a compression load on the elastomer bars 230.

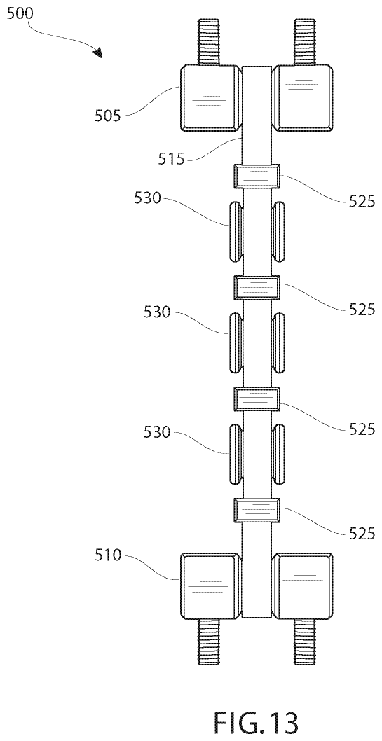

FIG. 12 is a perspective view of an alternative embodiment of the tension element implemented using a single strap. FIG. 13 is a side view of this alternative embodiment. In this alternative embodiment, the tension element 500 has a first attachment structure 505 and a second attachment structure 510. The tension element 500 further includes a flexible loop 515, a plurality of restrictors 525, and a plurality of elastomer bars 530 each including a rigid element 535.

The first and second attachment structures 505, 510 are used to attach the tension element 500 to the top of an isolation mount and to the bottom of the isolation mount respectively. The isolation mount is not shown. The various tension element to isolation mount attachment methodologies are described above with regard to other embodiments and apply similarly here. The first and second attachment structures 505, 510 further provide attachment for the flexible loop 515. Each of the attachment structures 505, 510 includes a channel 520, 522. Each channel 520, 522 is formed and configured to hold and support one of end of the flexible loop 515. The flexible loop 515, also referred to as a belt or a strap, circles the first and second attachment structures 505, 510. The flexible loop 515 is preferably made from a material that substantially resists deformation or stretching under tension. The plurality of restrictors 525, also called “clamp bars” or “restraining bars,” are devices that pinch the flexible loop 515 together to form holders to contain the elastomer bars 530. In one arrangement, the restrictors 525 are clips that are tightened around the flexible loop 515.

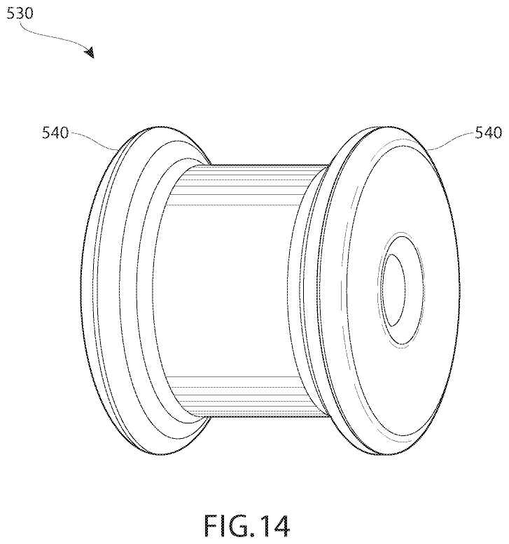

The plurality of elastomer bars 530, also referred to as “elastomeric elements” or “compressible elements,” are located in holders formed by the flexible loop 515 and restrictors 525. Each elastomer bar 530 is generally cylindrical in shape having enlarged ends. The elastomer bar 530 is described in more detail with regard to FIG. 14.

Each elastomer bar 530 includes a rigid element 535, also referred to as a “rod,” located along the axis of the elastomer bar 530. Typically, the rigid element 535 is a metal bar, for example a steel bar. The rigid element 535 provides some rigidity to the elastomer bar 530 to reduce bending of the elastomer bar 530. The rigid element 535 is also useful in tailoring the tension load deflection curve in the elastomer bar 530. Further, the rigid element 535 provides a compression stop for the elastomer bar 530.

In operation, a force putting the tension element 500 into tension is translated through the flexible loop 515 into a compressive load on the elastomer bars 530. The tension element 500 thereby provides the protection of resistance to excess motion in tension with the advantages of soft snubbing by transferring tension deflection of the isolator mount system into a compression load on the elastomer bars 530.

FIG. 14 is a perspective view of an elastomer bar 530 such as those seen in FIG. 12 and FIG. 13. The elastomer bar 530 has enlarged ends 540 configured to retain the elastomer bar 530 within the restricted flexible loop 515.

Alternative attachment configurations of embodiments of the tension element are possible such as attaching a tension element adjacent to the isolation mount. An alternative configuration includes only one attachment structure where the opposite end of the tension element is attached to the isolation mount directly or attached to a stable point adjacent to the isolation mount. Further configurations include, but are not limited to, a plurality of tension elements used in a single isolation mount, and a single or plurality of tension elements being shared by multiple isolation mounts. The attachment structure in a first arrangement is attached to the isolation mount with screws and in a second arrangement is attached to the isolation mount with brackets. The present inventions should not be considered limited to those attachment methods for the attachment structure described here. Other means of attaching the tension element to the isolation mount are possible. Alternative configurations of the tension element may have different numbers of elastomer bars or elastomeric elements. In further alternative embodiments of the tension element, the elastomeric elements foam materials. Further alternatively an elastomeric element may be an incompressible fluid in a flexible container. Further alternative embodiments of elastomeric elements include springs configured to be contained between the restrictors.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments. It is to be understood that the above-identified embodiments are simply illustrative of the principles of the invention. Various and other modifications and changes may be made by those skilled in the art which will embody the principles of the invention and fall within the spirit and scope thereof.

We claim:

1. A tension element, comprising:
a first attachment structure;
a second attachment structure;
a strap engaged with the first and second attachment structures;
a compressible element disposed within the strap; and,
a plurality of restrictors pinching the strap to form a holder holding the compressible element.

2. The tension element of claim 1 wherein the compressible element is an elastomer bar.

3. The tension element of claim 2 wherein the elastomer bar is cylindrical.

4. The tension element of claim 1 wherein the compressible element is coupled to the strap.

5. The tension element of claim 4 wherein the compressible element is coupled to the strap by adhesion.

6. The tension element of claim 2 wherein the elastomer bar further comprises a rigid element.

7. The tension element of claim 6 wherein the rigid element is a steel rod.

8. The tension element of claim 1 wherein at least one of the attachment structures is a restrictor.

9. The tension element of claim 1 wherein the first attachment structure and the second attachment structure each further comprise a channel, and where each of the channels is formed and configured to engage with the strap.

10. The tension element of claim 1 wherein each restrictor is further comprised of coupled opposing bars.

11. The tension element of claim 1 wherein the strap is made of metal.

12. The tension element of claim 1 wherein the strap is made of a woven material.

13. The tension element of claim 12 wherein the woven material is made of metal.

14. The tension element of claim 12 wherein the woven material is a woven reinforced composite material.

15. The tension element of claim 12 wherein the woven material comprises a stretch-resistant fiber.

16. The tension element of claim 1 further comprising a plurality of straps.

17. The tension element of claim 1 further comprising a plurality of compressible elements.

18. A tension element, comprising:
a first attachment structure having a first plurality of channels;
a second attachment structure having a second plurality of channels;
a plurality of straps formed and configured to engage with the first and second attachment structures, each strap of the plurality of straps engaged with a channel of the first plurality of channels and a corresponding channel of the second plurality of channels;
a plurality of elastomer bars disposed within the plurality of straps, each of the plurality of elastomer bars further including an axially-located rigid rod; and
a plurality of restrictors, each restrictor having a first bar and a second bar located in opposition, the plurality of restrictors clamping the plurality of straps at selected locations thereby forming a plurality of holders containing the plurality of elastomer bars such that a tensile force on the tension element causes the plurality of straps to exert a compressive force on the plurality of elastomer bars.
